(19) United States
(12) Patent Application Publication
(10) Pub. No.: US 2022/0203595 A1
(43) Pub. Date: Jun. 30, 2022

(54) PRODUCTION METHOD FOR CONTAINER HAVING COVERING LAYER

(71) Applicant: TOYO SEIKAN CO., LTD., Tokyo (JP)

(72) Inventors: Hiromitsu KIYOTO, Yokohama-shi, Kanagawa (JP); Hajime INAGAKI, Tokyo (JP)

(73) Assignee: TOYO SEIKAN CO., LTD., Tokyo (JP)

(21) Appl. No.: 17/608,343

(22) PCT Filed: Apr. 3, 2020
(86) PCT No.: PCT/JP2020/015328

§ 371 Date: Nov. 2, 2021

(30) Foreign Application Priority Data
Jun. 12, 2019 (JP) 2019-109589

(51) Int. Cl. B29C 49/22; B29C 49/06; B29C 49/64

(52) U.S. Cl. CPC B29C 49/221; B29C 49/06; B29K 2067/00; B29B 2911/1414; B29B 2911/14973; B29C 49/64

(57) ABSTRACT

A production method for a container having a covering layer includes forming a preform having a covering layer by using a thermoplastic synthetic resin; heating the preform from an outside of the preform with an infrared heater, and heating the preform from an inside of the preform with an internal heating unit; and forming the container having the covering layer by blow molding in which the heated preform is blown.

### TECHNICAL FIELD

The invention relates to a production method for a container having a covering layer.

### BACKGROUND ART

There is a known container made of a synthetic resin, the container being produced in such a manner that a preform is formed by using a synthetic resin, such as polyethylene terephthalate, and this preform is molded into a bottle shape by stretch blow molding or the like. The containers made of a synthetic resin are used as beverage containers that contain various beverages, for example.

There are known composite containers where the periphery of the container is covered by a covering layer so as to allow such containers to have various functions or characteristics. For example, Patent Literature 1 discloses a composite container and a production method for the composite container. In the disclosed production method, first, a preform made of a plastic material is prepared. Then, a plastic member is provided to surround the outer side of this preform, and the preform and the plastic member are brought into close contact with each other to prepare a composite preform. Next, blow molding is performed on the composite preform in a blow mold to cause the preform and the plastic member of the composite preform to inflate as an integral body. The composite container is produced in this manner.

### PRIOR ART DOCUMENT

### Patent Literature

### Patent Literature 1: JP 2016-112806 A

### SUMMARY OF INVENTION

With the increase in demand for the above-mentioned composite container, there is a demand for an efficient production method for a composite container.

It is an object of the invention to provide an excellent production method for a composite container.

One aspect of the invention is directed to a production method for a container having a covering layer, the production method including: forming a preform having a covering layer by using a thermoplastic synthetic resin; heating the preform from an outside of the preform with an infrared heater, and heating the preform from an inside of the preform with an internal heating unit; and forming the container having the covering layer by blow molding in which the heated preform is blown.

According to the invention, it is possible to provide an excellent production method for a composite container.

### BRIEF DESCRIPTION OF DRAWINGS

FIG. 1 is a cross-sectional view schematically showing a constitutional example of a container according to one embodiment.

FIG. 2 is a cross-sectional view schematically showing a constitutional example of a preform according to the embodiment.

FIG. 3A is a view for describing one example of preparation of the preform according to the embodiment, and is a view for describing primary injection molding.

FIG. 3B is a view for describing the example of preparation of the preform according to the embodiment, and is a view for describing secondary injection molding.

FIG. 4A is a view for describing one example of heating of the preform according to the embodiment.

FIG. 4B is a view for describing one example of heating of a heating rod according to the embodiment.

FIG. 5 is a view for describing one example of blow molding according to the embodiment.

### DESCRIPTION OF EMBODIMENT

One embodiment of the invention will be described with reference to drawings. This embodiment relates to a container made of a synthetic resin. This embodiment particularly relates to a production method for a container made of a synthetic resin. The container made of a synthetic resin according to this embodiment is a composite container having a multilayered structure.

[Container]

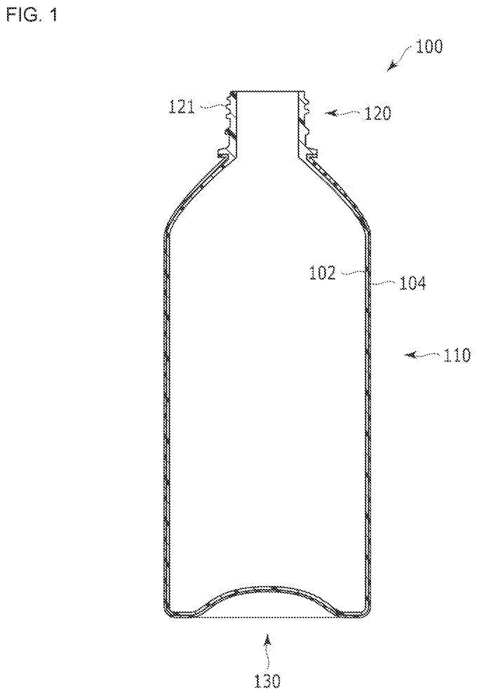

FIG. 1 is a longitudinal cross-sectional view schematically showing a configuration example of a container 100 according to this embodiment. In an example shown in FIG. 1, the container 100 is a bottomed bottle having a substantially cylindrical shape with a mouth at one end thereof. That is, as shown in FIG. 1, the container 100 includes a barrel portion 110 and a mouth portion 120, contents being stored in the barrel portion 110, contents being taken into and out from the container 100 through the mouth portion 120. The end portion of the container 100 on the side opposite to the mouth portion 120 is closed into a bottom portion 130. A screw thread 121 is formed on the mouth portion 120 to allow attachment of a cap not shown in the drawing.

The barrel portion 110, the mouth portion 120, and the bottom portion 130 of the container 100 are formed of a container body 102 as an integral body. The container 100 includes a covering layer 104 that covers the container body 102 on the barrel portion 110 and the bottom portion 130. As described above, the container 100 is a composite container having the covering layer.

The container body 102 is made of a thermoplastic resin. The container body 102 is formed by using an ethylene terephthalate-based thermoplastic polyester resin, such as polyethylene terephthalate, for example. The thermoplastic polyester resin is not limited to polyethylene terephthalate, and polybutylene terephthalate, polyethylene naphthalate, amorphous polyarylate, polylactic acid, polyethylene furanoate, copolymers thereof or the like may also be used. A mixture of these resins, a mixture of these resins and another resin or the like may also be used. Further, polycarbonate, an acrylonitrile resin, polypropylene, propylene-ethylene copolymer, polyethylene, or the like may also be used.

The covering layer 104 is also made of a thermoplastic resin. It is preferable that the covering layer 104 be formed by using a thermoplastic resin that is immiscible with a thermoplastic resin used for forming the container body 102. By using a thermoplastic resin that is immiscible with a thermoplastic resin used for forming the container body 102, the covering layer 104 can be easily peeled from the container body 102. Such a configuration facilitates recycling of the container 100. In the case where ethylene terephthalate-based thermoplastic polyester is used for forming the container body 102, it is preferable that a polyolefin-based resin, such as polyethylene or polypropylene, or ethylene-vinyl alcohol copolymer, or a polyimide-based resin, such as poly-meta-xylylene adipamide (MXD6), for example, be used for forming the covering layer 104.

The covering layer 104 may be colored, decorated, or caused to have various functions. For example, a pigment, a colorant, or the like may be added to color the covering layer 104. The covering layer 104 may have light-shielding property, for example. The container body 102 and the covering layer 104 can be easily separated and hence, recyclability of the colorless transparent container body 102 is maintained regardless of the colored covering layer 104.

[Production Method]

A production method for the container 100 according to this embodiment will be described. In this embodiment, the container 100 is produced by a so-called two-stage method. That is, first, a preform having a bottomed cylindrical shape is prepared by injection molding. Next, the preform is softened by heating. This softened preform is set in a mold, and is molded into a predetermined container shape by biaxially stretching blow molding.

<Preparation of Preform>

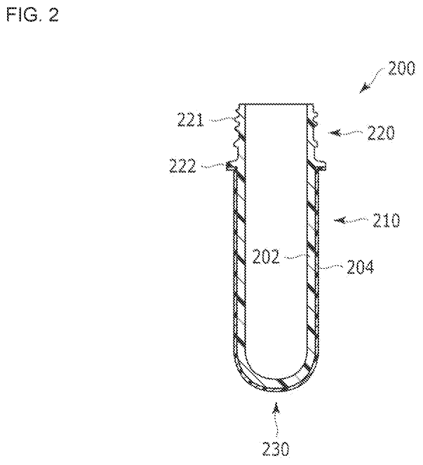

A configuration example of the preform prepared in this embodiment is schematically shown in FIG. 2. A preform 200 prepared in this embodiment has a substantially cylindrical shape with one end open and the other end closed. A mouth portion 220 is formed on the open end of the preform 200. The closed end of the preform 200 is referred to as a bottom portion 230. The bottom portion 230 has a hemispherical shape. A cylindrical portion between the mouth portion 220 and the bottom portion 230 is referred to as a barrel portion 210.

The mouth portion 220 of the preform 200 is not stretched in the blow molding, which is performed in a later stage. Accordingly, the mouth portion 220 of the preform 200 becomes the mouth portion 120 of the container 100 without any change. A screw thread 221 is formed on the outer peripheral surface of the mouth portion 220 of the preform 200 to allow attachment of a cap not shown in the drawing. A neck ring 222 is also provided to the barrel-portion-210 side of the mouth portion 220, the neck ring 222 annularly protruding along the circumferential direction.

The preform 200 includes a preform body 202 that forms the mouth portion 220, the barrel portion 210, and the bottom portion 230. The preform 200 also includes a preform covering layer 204 that covers the preform body 202 on the barrel portion 210 and the bottom portion 230. The preform covering layer 204 is provided up to the end surface of the neck ring 222 on the bottom portion 230 side.

In the blow molding, which is performed in a later stage, the preform body 202 is stretched to form the container body 102 of the container 100, and the preform covering layer 204 is stretched to form the covering layer 104 of the container 100. The preform body 202 and the preform covering layer 204 are integrally stretched.

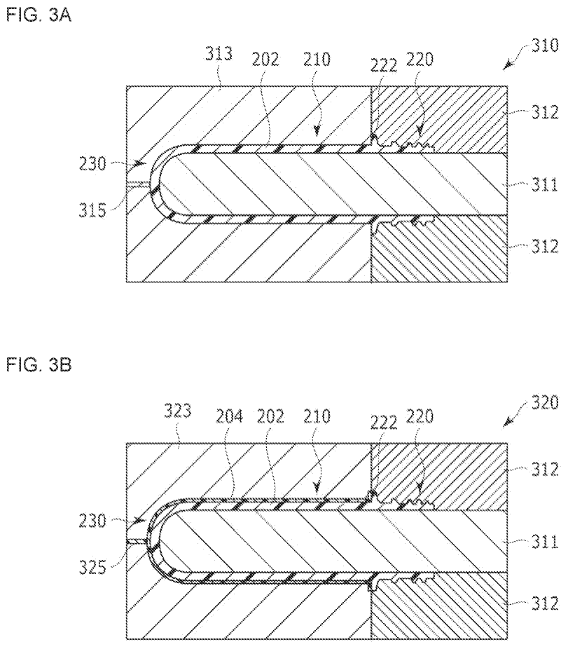

A preparation method for the preform will be described with reference to FIG. 3A and FIG. 3B. The preform is prepared by a so-called double injection molding (two-color injection molding) method.

First, the preform body 202 is formed by injection molding. As shown in FIG. 3A, a primary injection mold 310 is used for molding the preform body 202. The primary injection mold 310 includes a core mold 311, a mouth portion mold 312, and a primary barrel mold 313. The core mold 311 is a male mold for molding the inner surface of the preform body 202. When the mold is opened, the core mold 311 is moved relative to the preform 200 parallel to the center axis of the preform. The mouth portion mold 312 is a female mold for molding the outer peripheral surface or the like of the mouth portion 220 ranging from the neck ring 222 to the opening end side of the preform body 202. The mouth portion mold 312 includes a plurality of molds that slide in a direction perpendicular to the center axis of the preform 200 when the mold is opened. The primary barrel mold 313 is a female mold for molding the outer peripheral surface of the barrel portion 210 and the bottom portion 230 ranging from the neck ring 222 to the closed end side of the preform body 202. When the mold is opened, the primary barrel mold 313 is moved relative to the preform 200 parallel to the center axis of the preform. A gate 315 is provided to the primary injection mold 310 for filling a thermoplastic resin into a cavity that is formed when the primary injection mold 310 is clamped.

A heated and melted thermoplastic resin is injected into the cavity of the clamped primary injection mold 310 via the gate 315. After the resin is injected, the resin is solidified by cooling. Then, the formed preform body 202 is removed from the primary barrel mold 313 together with the core mold 311 and the mouth portion mold 312.

In the following step, the preform covering layer 204 is formed on the outer periphery of the barrel portion 210 and the bottom portion 230 of the preform body 202 by injection molding. As shown in FIG. 3B, a secondary injection mold 320 is used for molding the preform covering layer 204. In the secondary injection mold 320, the core mold 311 and the mouth portion molds 312 that are used in the primary injection mold 310 are also used in common. In the secondary injection mold 320, a secondary barrel mold 323 is further used. The secondary barrel mold 323 is configured to form, between the secondary barrel mold 323 and the molded preform body 202, a cavity with a thickness that corresponds to the thickness of the preform covering layer 204. A gate 325 is provided to the secondary injection mold 320 for filling a thermoplastic resin into the cavity that is formed when the secondary injection mold 320 is clamped.

A heated and melted thermoplastic resin is filled into the cavity of the clamped secondary injection mold 320 by injection via the gate 325. After the resin is injected, the resin is solidified by cooling. Then, the mold is opened to take out the preform 200 that includes the formed preform covering layer 204 and the formed preform body 202.

In this embodiment, the description has been made by taking the case where the preform 200 is prepared by using the double injection molding method as an example. However, the preparation method for the preform 200 is not limited to the above. Compression molding or the like may be used for the preparation of the preform 200. Further, the preform covering layer 204 may be formed such that a heat shrink material is disposed around the preform body 202 and is heat-shrunk.

According to the double injection molding, the preform covering layer 204 can be easily formed such that the preform covering layer 204 covers the entire bottom portion 230 of the preform 200. That is, it is possible to easily form the covering layer 104 that covers the entire bottom portion 130 of the container 100.

<Heating Method for Preform>

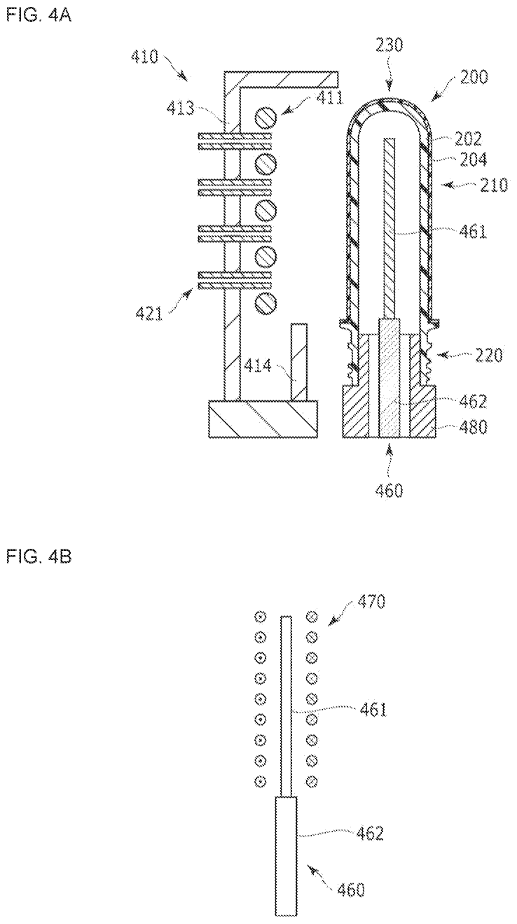

The container 100 is formed by blow molding by using the preform 200, which is prepared as described above. A heating method for the preform 200 will be described with reference to FIG. 4A and FIG. 4B, the heating being performed prior to blowing.

FIG. 4A is a view schematically showing the configuration of a device relating to heating of the preform 200. In this embodiment, the preform 200 is heated by using an external heating unit 410 and an internal heating unit 460, the external heating unit 410 being provided outside the preform 200, the internal heating unit 460 being inserted into the preform 200. The external heating unit 410 includes an infrared heater 411. The infrared heater 411 heats the preform 200 by radiant heat. The internal heating unit 460 includes a heating rod 461. The heating rod 461 may be a rod made of metal, for example. The heating rod 461 is inserted into the preform 200 in a state of being heated in advance, and the heating rod 461 heats the preform by radiant heat. The preform 200 is heated from the outside by the external heating unit 410 and is heated from the inside by the internal heating unit 460 and hence, the entire preform 200 can be appropriately heated.

In general, heating of the preform is often performed by using an infrared heater that is provided outside. However, the preform 200 according to this embodiment has a two-layered structure of the preform body 202 and the preform covering layer 204. Particularly, in a case where the preform covering layer 204 has low infrared transmittance due to the preform covering layer 204 being colored or having light shielding properties, the inner side of the preform body 202 is not easily heated with only the external heating unit 410. In the case of this embodiment, in addition to the external heating unit 410, the internal heating unit 460 that is inserted into the inside of the preform 200 is used and hence, even when the preform covering layer 204 has low infrared transmittance, the entire preform 200 can be heated to an appropriate temperature within a short time period.

The preform 200 is held by a holder 480 having a substantially cylindrical shape, for example. The preform 200 is held by the holder 480 such that the holder 480 is inserted into the mouth portion 220 with the bottom portion 230 being in an upper position and with the mouth portion 220 being in a lower position. The holder 480 conveys the preform 200 in the horizontal direction. Further, the holder 480 can rotate about the axis thereof. The internal heating unit 460 can move in the horizontal direction and the vertical direction.

The holder 480 conveys the preform 200 to the external heating unit 410 that radiates infrared rays. During a period in which the preform 200 passes in front of the external heating unit 410, the preform 200 is heated by the external heating unit 410. When the preform 200 passes in front of the external heating unit 410, the internal heating unit 460 moves in the horizontal direction together with the holder 480. Before and after the preform 200 passes through the external heating unit 410, the internal heating unit 460 also moves in the vertical direction. When the preform 200 passes through the external heating unit 410, the internal heating unit 460 is inserted into the preform 200 via the hollow portion of the holder 480. During a period in which the internal heating unit 460 is inserted into the preform 200, the preform 200 is heated by the internal heating unit 460.

A plurality of holders 480 successively convey a plurality of preforms 200 to the external heating unit 410 and hence, a large quantity of preforms is successively heated.

The external heating unit 410 includes a plurality of infrared heaters 411, a first reflection plate 413, and a second reflection plate 414. The infrared heater 411 radiates infrared rays to heat the preform 200. The plurality of infrared heaters 411 may be configured so that an output from each of the plurality of infrared heaters 411 can be individually adjusted. The first reflection plate 413 is provided on the side opposite to the preform 200 with respect to the infrared heater 411. The first reflection plate 413 reflects infrared rays radiated to the side opposite to the preform 200 so as to increase energy efficiency of the external heating unit 410. The second reflection plate 414 is provided between the infrared heaters 411 and the mouth portion 220 of the preform 200. The second reflection plate 414 shields infrared rays to prevent the mouth portion 220 of the preform 200 from being heated, the mouth portion 220 of the preform 200 not being deformed in the blow molding, which is performed in a later stage.

In another embodiment, the external heating unit 410 may have a plurality of air outlets 421. Cooling air is blown out from the outlets 421 toward the preform 200. The plurality of outlets 421 may be configured so that an amount of air blown out from each of the plurality of outlets 421 can be individually adjusted. The external heating unit 410 may not have the outlets 421.

The internal heating unit 460 includes the heating rod 461 and a heat insulator 462. The heating rod 461 is made of metal that can be easily heated by induction heating. The heating rod 461 is configured to be disposed at a position corresponding to the barrel portion 210 and the bottom portion 230 of the preform 200 that should be heated. The heat insulator 462 is configured to be disposed at a position that corresponds to the mouth portion 220 of the preform 200 that should not be heated.

The heating rod 461 made of metal is heated by induction heating before the heating rod 461 is inserted into the preform 200. Accordingly, as shown in FIG. 4B, the heating rod 461 is inserted into an induction coil 470. The heating rod 461 is heated to approximately 400° C. to 600° C., for example. The heating rod 461 is heated to approximately 500° C., for example. The inner surface of the preform 200 can be easily heated to approximately 140° C., for example, by such a heating rod 461. In this manner, the temperature of the preform body 202 made of polyethylene terephthalate, for example, can be increased to approximately 110° C. to 120° C., for example, which has preferable moldability.

By adjusting density of the induction coil 470 or by adjusting power applied to the induction coil 470 in the longitudinal direction of the heating rod 461, temperature distribution in the heating rod 461 in the longitudinal direction can be appropriately adjusted according to requirements in heating the preform 200. The thickness, the length, the shape, and the like of the heating rod 461 may be adjusted according to requirements in heating the preform 200.

In this embodiment, the preform 200 is heated from the outside of the preform 200 by using the infrared heater 411 of the external heating unit 410, and the preform 200 is also heated from the inside of the preform 200 by using the heating rod 461 of the internal heating unit 460. At this point of operation, the preform 200 is rotated about the longitudinal axis thereof by the holder 480 and hence, the preform 200 is uniformly heated in the circumferential direction.

With respect to heating from the outside, temperature distribution in the preform 200 in the longitudinal direction can be adjusted by adjusting an output from each of the plurality of infrared heaters 411. In the case where the outlets 421 are provided, temperature distribution in the preform 200 may also be adjusted by making use of blowing air to the preform 200. With respect to heating from the inside, temperature distribution in the preform 200 in the longitudinal direction can be adjusted by adjusting temperature distribution in the heating rod 461 in the longitudinal direction.

In this embodiment, an example has been described where the heating rod 461 is used as the internal heating unit 460. However, the internal heating unit 460 is not limited to the heating rod 461. For example, a cartridge heater may be used for the internal heating unit 460. That is, the inside of the preform 200 may be heated by heat generated from the cartridge heater that is inserted into the preform 200.

<Blow Molding>

The heated preform 200 is conveyed to a blow molding apparatus. The container 100 is formed by performing blow molding on the heated preform 200. The blow molding apparatus successively performs blow molding on the heated preforms 200, which are successively conveyed, by using a plurality of blow molds.

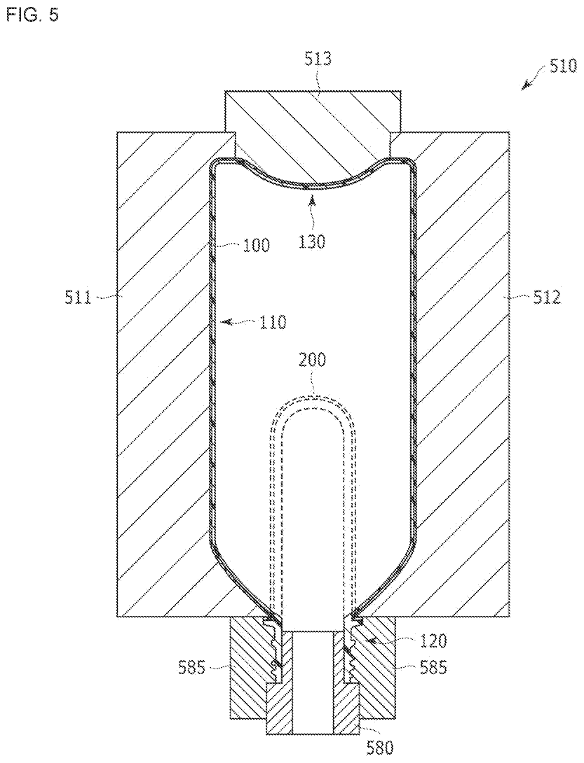

The blow molding will be described with reference to the schematic cross-sectional view shown in FIG. 5. In FIG. 5, broken lines schematically show the shape of the preform 200 before blow molding is performed.

The preform 200 is conveyed in a state of being held by a holder 580 that also serves as a blow nozzle configured to blow air into the preform 200. The holder 580 has a substantially cylindrical shape, and is inserted into the mouth portion 220 of the preform 200. For the holder 580 used in this embodiment, the holder 480 that is used at the time of heating the preform 200 may be directly used. In the blow mold, the mouth portion 220 is fixed by a fixing member 585 that surrounds the periphery of the mouth portion 220. Portions of the preform 200 that are closer to the bottom portion 230 than the neck ring 222, such as the barrel portion 210, are disposed in a blow mold 510 having a hollow cavity when the blow mold 510 is closed.

The blow mold 510 includes, for example, a first barrel mold 511, a second barrel mold 512, and a base mold 513, the first barrel mold 511 and the second barrel mold 512 being provided for mainly forming the shape of the barrel portion 110 of the container 100, the base mold 513 being provided for mainly forming the shape of the bottom portion 130 of the container 100. The configuration of the blow mold 510 described in this embodiment is merely for the sake of example, and the configuration of the blow mold 510 is not limited to the above.

The preform 200 disposed in the closed blow mold 510 is stretched by using a stretching rod and pressurized air, for example. The preform 200 is stretched in the axial direction by the stretching rod not shown in the drawing, for example, and is stretched in the axial direction and the circumferential direction by blow air that is blown into the preform 200. As a result, the container 100 that conforms to the inner surface shape of the blow mold 510 is formed. The preform body 202 and the preform covering layer 204 of the preform 200 are integrally stretched. As a result, the container body 102 and the covering layer 104 that covers the container body 102 are formed.

In this embodiment, in the heating performed prior to the blow molding, the preform 200 is heated from the outside of the preform 200 by using the infrared heaters 411, and is also heated from the inside of the preform 200 by using the internal heating unit 460. Accordingly, even in the case where infrared rays radiated from the infrared heaters 411 cannot easily reach the preform body 202, such as the case where the preform covering layer 204 is colored with a dark color, the preform body 202 can be heated by the heating rod 461.

Even if the internal heating unit 460 is not used, when the preform 200 is left for a period after the outer side of the preform 200 is heated, heat is transferred to the inner side of the preform 200 and hence, the temperature of the preform body 202 can be increased. However, this case requires some time to transfer heat. This method may reduce molding cycle of the container 100, thus reducing production efficiency. Alternatively, this method may increase the transfer distance of the preform in a production machine, thus increasing production costs.

Further, if the temperature of the outer portion of the preform 200 is excessively increased, there is a possibility that the preform covering layer 204 is unintentionally deformed. Therefore, it is necessary to appropriately adjust the degree of heating. Particularly, it is confirmed that the preform covering layer 204 in the vicinity of the mouth portion 220 is easily deformed.

In contrast, this embodiment does not require the above-mentioned time to transfer heat. It is also unnecessary to increase the temperature of the outer side of the preform 200 to a temperature at which the preform covering layer 204 is deformed. Each of an output from the external heating unit 410 and an output from the internal heating unit 460 can be suitably adjusted according to various requirements. For example, it is possible to easily set the temperature of the preform body 202 to be higher than the temperature of the preform covering layer 204. Therefore, according to this embodiment, it is possible to efficiently produce the container 100 where the covering layer 104 is provided to cover the container body 102.

To protect contents of the container 100 from external light, the container 100 may be required to have light shielding property. According to this embodiment, it is possible to produce the container 100 that achieves such light shielding property by the covering layer 104. By adopting a configuration where the container body 102 is colorless and transparent, the covering layer 104 is colored, and the covering layer 104 can be easily separated from the container body 102, the container 100 can achieve both suitable recycling of the container body 102 and coloring of the container 100.

The invention has been described heretofore with reference to the preferred embodiments. However, the invention is not limited to the above-mentioned embodiment, and it is needless to say that various modifications are conceivable without departing from the scope of the invention.

The contents of the documents described in this Description and the Description of the Japanese application that is the basis of Paris priority of the present application are all incorporated herein.

### REFERENCE SIGNS LIST

100 container
102 container body
104 covering layer
110 barrel portion
120 mouth portion
121 screw thread
130 bottom portion
200 preform
202 preform body
204 preform covering layer
210 barrel portion
220 mouth portion
221 screw thread
222 neck ring
230 bottom portion
310 primary injection mold
311 core mold
312 mouth portion mold
313 primary barrel mold
315 gate
320 secondary injection mold
323 secondary barrel mold
325 gate
410 external heating unit
411 infrared heater
413 first reflection plate
414 second reflection plate
421 outlet
460 internal heating unit
461 heating rod
462 heat insulator
470 induction coil
480 holder
510 blow mold
511 first barrel mold
512 second barrel mold
513 base mold
580 holder
585 fixing member

1. A production method for a container having a covering layer, the production method comprising:
forming a preform having a covering layer by using a thermoplastic synthetic resin;
heating the preform from an outside of the preform with an infrared heater, and heating the preform from an inside of the preform with an internal heating unit; and
forming the container having the covering layer by blow molding in which the heated preform is blown.

2. The production method according to claim 1, wherein
the internal heating unit includes a heating rod configured to be inserted into the preform,
the production method further comprises heating the heating rod, and
the heating the preform from the inside of the preform includes inserting the heating rod heated into the preform.

3. The production method according to claim 2, wherein the heating the heating rod includes heating the heating rod to 400° C. to 600° C.

4. The production method according to claim 1, wherein the forming the preform includes forming the covering layer by using a material having light shielding property.

5. The production method according to claim 1, wherein the forming the preform includes forming the preform by a double injection molding method.

6. The production method according to claim 1, wherein
a body of the container is formed by using a thermoplastic polyester resin, and
the covering layer is formed by using a polyolefin-based resin.
